(19) United States
(12) Patent Application Publication
(10) Pub. No.: US 2008/0097771 A1
(43) Pub. Date: Apr. 24, 2008

(54) System and Method for Creating Distributed Applications Utilizing Portable Devices and Physical Location of the Portable Device

(75) Inventors: Michael Flom, Allendale, NJ (US); Joseph Polizzano, Glen Rock, NJ (US)

Correspondence Address: SYNNESTVEDT LECHNER & WOODBRIDGE LLP, P O BOX 592, 112 NASSAU STREET, PRINCETON, NJ, 08542-0592, US

(73) Assignee: PORTABLE INTERNET, INC., Fair Lawn, NJ (US)

(21) Appl. No.: 11/572,820

(22) PCT Filed: Jul. 29, 2005
(86) PCT No.: PCT/US05/27362

§ 371 Date: Jan. 29, 2007

Related U.S. Application Data
(60) Provisional application No. 60/592,188, filed on Jul. 29, 2004.

(51) Int. Cl. G06Q 10/00

(52) U.S. Cl. 705/1

(57) ABSTRACT

A system and method for creating and deploying distributed applications. A template defines a business process by means of validation, input, permission and workflow rules. The specific business process is performed by first creating a document that is a particular instantiation of the template. The document embeds all of the rules of the template along with data particular to that particular process. The document may then be assigned to a specific user, and be delivered over a wireless network. The user may view and/or update portions of the document and forward the document to a next participant in the process, all according to the embedded rules. Document updates may incorporate input from external sensors such as Global Positioning Satellite (GPS) and bar code scanners. After instantiation, the document is independent of the original template, with the document holding the actual results of the business process throughout the process.

### CROSS REFERENCE TO RELATED APPLICATIONS

This application is related to, and claims priority from U.S. Provisional Patent application no. 60/592,188 filed on Jul. 29, 2004 by Name et al. titled “System and Method for Creating Distributed Applications Utilizing Portable Devices” , the contents of which are hereby incorporated by reference.

TECHNICAL FIELD

The present invention relates to systems and methods for creating, distributing, and updating information, and more particularly to systems and methods for creating, distributing, and updating information in a distributed system of Internet-based applications and programmable portable devices.

### BACKGROUND ART

As portable wireless devices, such as cell phones and personal digital assistants have increased in computing power and Internet connectivity, they have become used to deliver and collect information in order to execute to execute a business process. The browser technologies used on these portable wireless devices, such as, but not limited to Wireless Application Protocol (WAP), Website Meta Language (WML) and Hyper Text Markup Language (HTML), have, however, approached delivering and receiving data from these wireless devices as if they were simply an extension of the wired Internet. This has taken the form of embedding the browsers on the portable devices and using them to access the Internet as if they were Personal Computer (PC) based browsers. That is, they rely on a constant connection to send information to the portable device and for that connection to be maintained as the user of the portable device enters additional information. However, portable devices are operating in a wireless environment where connectivity to the Internet is very often intermittent. Browser based solutions, which are synchronous in nature, often fail in practice to provide a reliable means to deliver and update information.

One attempt at resolving this problem involves delivering a sequence of static pages containing “forms”, designed in HTML or a variant thereof, to the portable device, where the form defines the data to be collected. A user can enter information in a form and submit the form to a central server when complete. Connectivity is not required while information is entered into the form. However, the definition of each form has to be defined in a server-based repository. When a form on the central server is modified, a common practice as applications evolve, any portable device that still has the old form has to be resynchronized to obtain the new form. Since connectivity with portable devices is intermittent, the delivery of the new form to hundreds or even thousands of portable devices may take hours, days, or even weeks. During this period, any data submitted is based on the old form, requiring an individual with Information Technology (IT) skills to write, test and install a program on the server to translate all the collected information to the new form. It is a very complex and problem-prone process to ensure backward compatibility across multiple versions of forms. Thus, the vast majority of wireless applications are extremely simple and unsuitable for complex business processes.

Another attempt at resolving this problem is database synchronization, in which a local application is installed on each portable device or computer system. The database on the portable devices and the databases on the server are periodically synchronized. This method requires an application installation on each device for each change in business rules. Many businesses have hundreds, even thousands of distributed devices, making this a very labor intensive process. Moreover, such a method requires that all the changes are submitted during a periodic synchronization, instead of as each change occurs, making the result less, or un-responsive, to immediate changes in an application's data.

### DISCLOSURE OF INVENTION

The present invention is a system and method for creating and deploying distributed applications that reduces or eliminates the problems and disadvantages associated with previous techniques for deploying distributed applications involving Internet-based applications and portable computing devices.

In a preferred embodiment of the present invention, a template is used to define a particular business process by means of a set of rules relating to that particular business process. The rules include validation, input, permission and workflow rules. Any number of templates may be created to define a variety of business processes, each customized to a particular business or industry, and these may be stored in, for instance, a central repository.

To initiate and carry out a specific business process, a document is instantiated, or created, using a particular template. When instantiated, the document embeds all of the rules of that template and, thereafter, is independent of the original template. The document may then be assigned to a specific user. The user may view and/or update portions of the document according to the embedded rules and independent of the original template. Document updates may incorporate input from external sensors such as, but not limited to, Global Positioning Satellite (GPS) and bar code scanners. The document may then be forwarded to a next participant in the workflow process, based on the embedded rules. If the user is accessing the document from a portable device, the document may be delivered over the wireless Internet to that device where it may be similarly viewed, updated and submitted to yet another user. And all of this functionality is independent of the original template, and means that the document holds the actual results of the business process.

Any document may be reassigned or closed via a central document management component, either manually or under the control of an external program. One or more documents may be viewed, summarized, aggregated, or exported to another computer system, entirely independent of the original templates.

In a further embodiment of the invention, templates may be developed externally and imported into the template repository of an organization.

In a further embodiment of the invention, a Geographic Information System (GIS) may be used to display the locations recorded in a Document on a map or in reports.

These and other features of the invention will be more fully understood by reference to the following drawings.

BRIEF DESCRIPTION OF DRAWINGS

FIG. 1 is schematic drawing showing an exemplary embodiment of the present invention.

FIG. 2 is a schematic drawing showing an exemplary template and an exemplary instantiated document of the present invention.

FIG. 3 is a schematic drawing showing an embodiment of the invention in which a document is distributed to multiple users in a workflow.

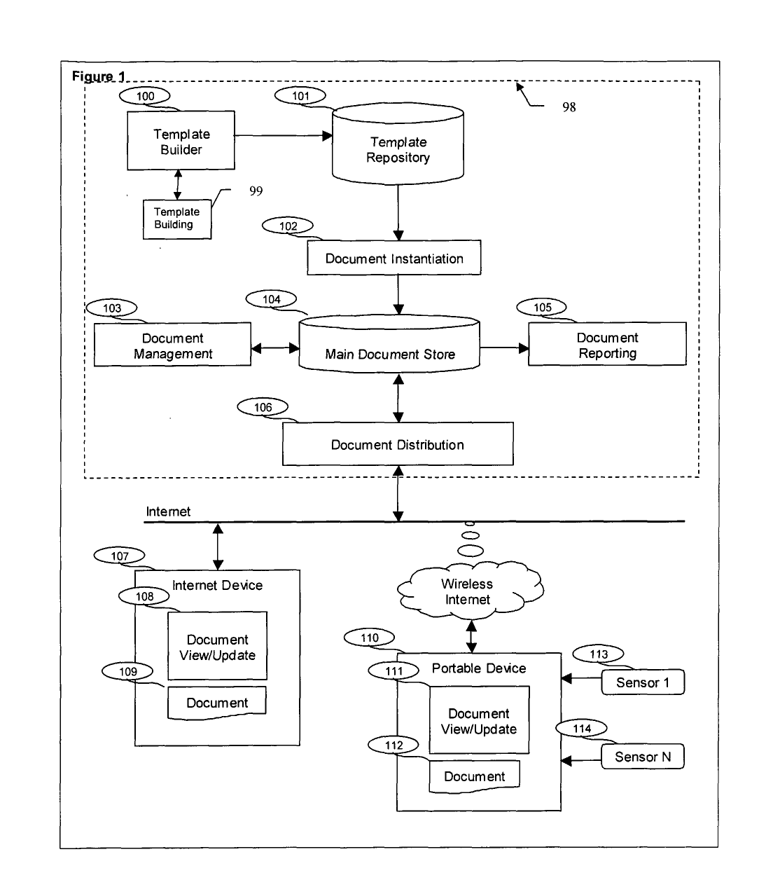

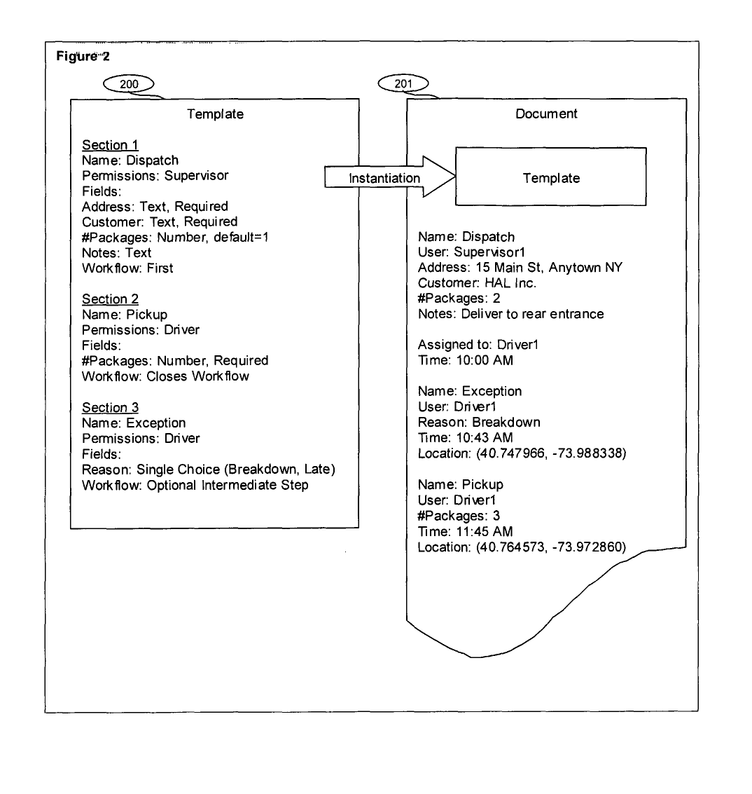

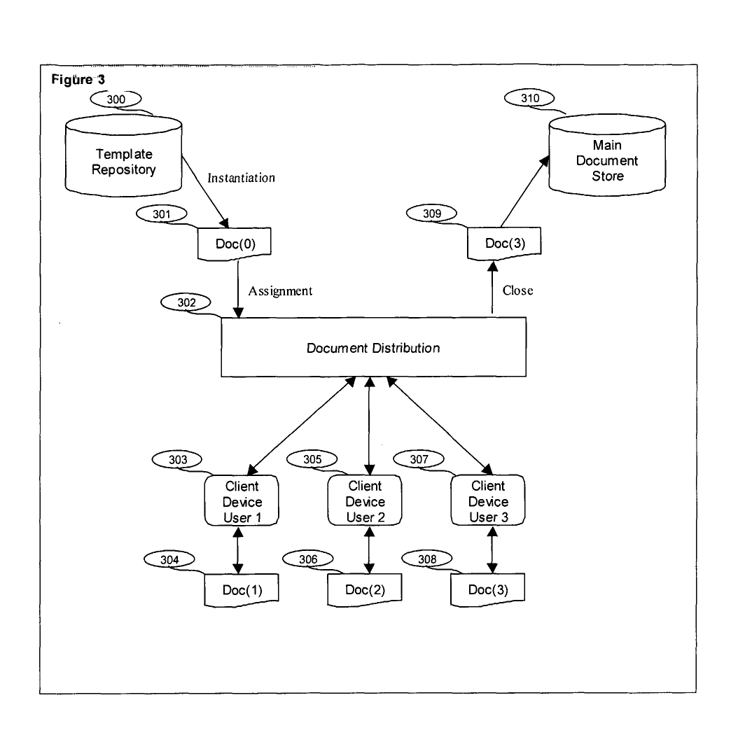

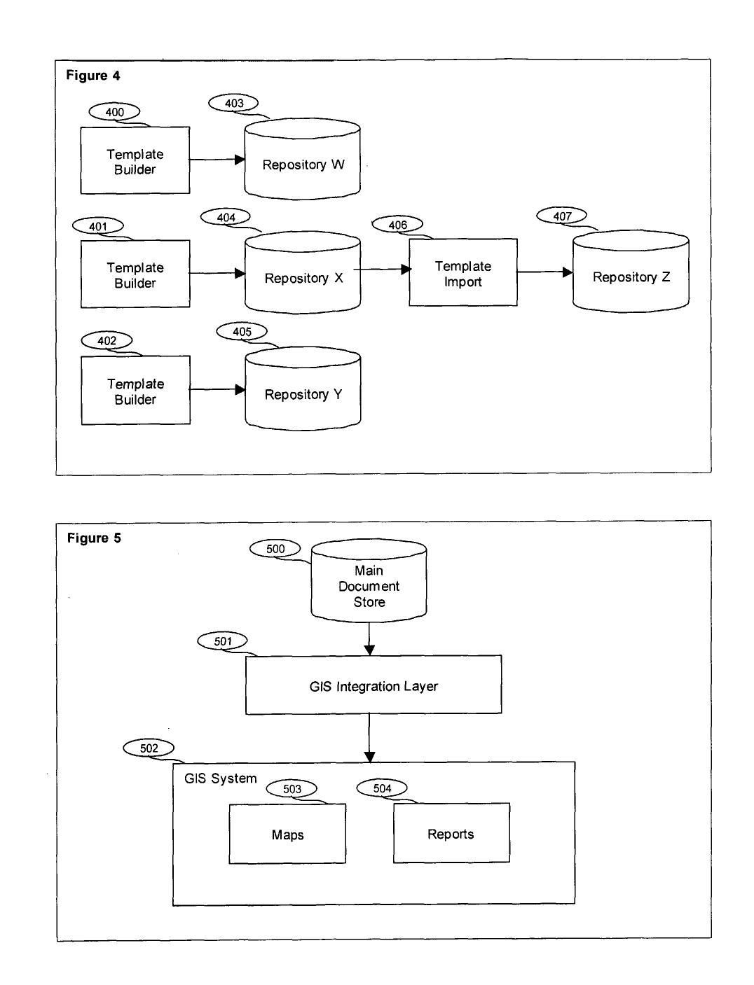

FIG. 4 is a schematic drawing showing an embodiment of the invention which incorporates external template i libraries.

FIG. 5 a schematic drawing showing an embodiment of the invention which incorporates a GIS System.

### BEST MODE FOR CARRYING OUT THE INVENTION

In describing the inventions, specific terminology is employed for sake of clarity. However, the present disclosure is not intended to be limited to the specific terminology so selected and it is to be understood that each specific element includes all technical equivalents that operate in a similar manner. It is understood that the drawings and examples are for illustration only and are not limiting.

The present invention relates to a system and method for creating, distributing, and updating information in a distributed system of Internet-based applications and programmable portable devices.

In a preferred embodiment, documents that define a particular instance of a business process are instantiated from a central repository of business process templates. The documents used to execute and record the results of the specific instance of the business process. Once initiated, the documents are completely and permanently independent of the central repository templates.

In a preferred embodiment, the documents and related applications may be location-enabled by means of, for instance, a Global Positioning Satellite (GPS) enabled workflow system administrated by a web portal. The system may concurrently accommodate an unlimited number of versions of the documents, the applications and changes to the documents and applications. The system and method of this invention may enable data, applications and documents to be automatically delivered and installed, without any user intervention, on to the device where the documents, applications and data are to be used. Moreover, only occasional connectivity to the device where the documents are to be used is required to perform the either accommodation of multiple document versions or their delivery.

The system and method of this invention will now be described in detail with reference to the attached drawings in which, as far as possible, like numbers represent like elements.

FIG. 1 is schematic drawing showing an exemplary embodiment of the present invention as a system block diagram.

In a preferred embodiment, templates are used to define the validation, input, permission, and workflow rules of a business process. Template building 99 is done using a template builder 100 that may be a component such as, but not limited to, a software module running on one or more hardware platforms, such as a computing device 98 having a suitable user interface and console. The template builder 100 is capable of building, editing and storing a specific template. The template builder 100 may be constructed as a software module running on the computing device 98 using any suitable computing technology including, but not limited to, an Internet application using HTML, Website Meta Language (WML), or other browser, a Personal Computer (PC) program, or a portable device program or any suitable combination thereof. The template builder 100 may directly generate template definitions, or may present a text or graphical user interface to aid in the manual building of a template. Individual templates may be stored in a template repository 101. The template repository may be any type of persistent data storage and associated software modules operable on, for instance, the computing device 98, and capable of storing and accessing individual templates, including but not limited to a relational database, an eXtensible Markup Language (XML) database, a flat files or other searchable data structure. The individual templates may be stored in any format including but not limited to XML, HTML, eXtended Hypertext Markup Language (XHTML), eXtensible Stylesheet Language (XSL), name/value pairs, text, binary, or other suitable formatting language.

The templates define a business process workflow and may consist of validation, input, permission, and workflow rules.

Validation rules define the rules for validation such as, but not limited to, rules for displaying and updating all of the fields in the given business process including for each field, but not limited to, a field name; an indication of whether the field is required or optional; an indication of whether the contents of the field must be unique across all instantiated documents using this template; a field type to define acceptable data entry value such as number, currency, decimal, text, multiple choice, single choice, image, audio, video and others; a field validation rule defining ranges of acceptable field values using simple or complex Boolean expressions, and optionally including the value of other fields; a default value, defined as a constant or by the contents of another field.

Input rules define rules for inputting data such as, but not limited to, the rules defining the mechanism by which the value of field may be entered such as keyboard, a keypad, a voice recorder, a bar code scanner, a camera, a Radio Frequency Identification (RFID) sensor, or other connected sensor or input device.

Permission rules define permissions such as, but not limited to, what type of user may view and/or update the fields of a document.

Workflow rules define rules for the flow of work such as, but not limited to, the sequence of the business process, the routing from user to user, and the sections of the Document that may be viewed and/or updated during the workflow.

To execute a specific business process, an appropriate template is selected and used to instantiate, i.e., create, a new document. The document instantiation module 102 is a component that, given a template in the template repository 101, creates a new document embedding all of the rules of the template into the document. The document is the actual object used to present and capture information throughout the business process and is completely independent of the original template. The original template may be modified or even deleted with no affect on already instantiated documents or the already ongoing business processes. The document instantiation module 102 is triggered whenever a new instance of a business process is to be executed. The instantiation may be triggered manually via a user interface program, or from an external system under computer program control, including web-based systems. The instantiated documents are stored in main document store 104.

FIG. 2 depicts an example of a template 200 and an instantiated document 201. The example illustrates a template 200 and an instantiated document 201 associated with an exemplary business process in which a supervisor dispatches a driver to an address to pickup a package. The template 200 illustrates the major components of the exemplary business process. Section 1 is a section of the template that defines the fields that specify the address, customer name, and number of packages for this business process. The template 200 contains the specific, but exemplary, validation rules, permission rules, and workflow rules for this exemplary business process. The document 201 illustrates the process of embedding the rules associated with template 200 into the document at the time of instantiation, and the typical nature of the information recorded during the execution of this business process. In this example, Supervisor 1 is the name of a user that is recognized by the system as having the status of supervisor and, therefore, has the necessary permission to update the document with an actual address. In this instance, the user has added the fictitious address 15 Main St, Anytown N.Y. Supervisor 1 has also provided the document with an actual customer, in this instance the fictitious company HAL Inc, and the number of packages involved in the business process, in this instance, 2 packages. The user, Supervisor 1, has also completed the notes field, with instructions to the person assigned to carry out the business process. As these fields were entered, the rules in the embedded template, not the original template, were used to validate updates. Continuing with the example, at 10:00 AM Supervisor 1 assigned the document to Driver 1. Driver 1 then updated the document indicating an Exception in the form of a breakdown which occurred at 10:43 AM at the specified latitude/longitude. Driver 1 then updated the document indicating that he picked up 3 packages at 11:45 AM at the specified latitude/longitude. The pickup of the packages closes out the business process, according to the embedded workflow rules. One of ordinary skill in the relevant arts would readily appreciate that the business process presented above is merely illustrative and does not limit the rules or processes that can be implemented by this invention in any way.

Returning to FIG. 1, the instantiated documents may be stored in the Main Document Store 104. The Main Document Store 104 may be any type of persistent data storage that is capable of storing and accessing individual documents, including but not limited to a relational database, an XML database, flat files, or other suitably searchable data storage medium, including all the necessary software modules and associated hardware.

The Document Distribution module 106 is a component that distributes instantiated documents to users. Distribution rules may be embedded within the document itself, or specified manually using an appropriate user interface program, or specified by an external system under computer program control including web-based systems. When a document is assigned to a user, Document Distribution 106 transfers the document to a client device accessible to the user. The document may be transferred in any format including, but not limited to, XML, HTML, XHTML, XSL, name/value pairs, text, binary, compressed, or other suitable document format. The document format may vary based on the computing power of the end user device.

The document may be transferred over any suitable connection, including, but not limited to, the Internet and the Wireless Internet. The client device is a component that displays and allows update of the transferred document. The validation, input, permission, and workflow rules embedded in the document direct the display and/or update of the document, completely independent of the original template. The client device may be any programmable computer device with a connection to the Internet including but not limited to Personal Computers, cell phones, Personal Digital Assistants, Smart Phones or other suitable electronic communications device.

The Internet Device 107 and Portable Device 110 illustrate two examples of a client device. The Internet Device 107 illustrates a client device with a wired connection to the Internet. The Document View/Update module 108 is a component that facilitates display of the document and allows the transferred document, denoted as Document 109 in FIG. 1, to be updated with in the constraints of the embedded input, validation, and permission rules. The Portable Device 110 illustrates a client device that may be resident on a portable device with a wireless connection to the Internet. The Document View/Update module 111 is a component that displays allows the update of the transferred document 112, constrained by the embedded input, validation, and permission rules.

When a user updates a document using a client device, the document may be transferred to the Document Distribution 106 component where it may be further updated in the Main Document Store 104 and, based on the embedded workflow, the document may be distributed to another user or closed.

The Document Management module 103 provides a mechanism to manage documents across one or more users. The documents under management may be reassigned to another user, forced closed independent of the document workflow rules, or deleted. The fields of a specific document may be changed. If a document changes, Document Distribution module 103 may remove the document from the prior user and transmit it to the new user. The document changes may be triggered manually via a user interface program or from an external system under computer program control including web-based systems.

The Document Reporting module 105 is a component that provides a mechanism to view documents in the Main Document Store 104. Viewing of a document may occur by the document being presented to a user in any suitable format including, but not limited to, text, tables, hierarchical lists, graphs, or other suitable viewing format. The Document Reporting module 105 may provide suitable summarization and aggregation across the fields of one or more documents, using, for instance, the field validation rules as an aid, and may be completely independent of the original templates.

In one embodiment, one or more sensors connected to the client devices are used to update one or more fields of a document. The sensor 113 and the sensor 114 in FIG. 1 depict exemplary sensors connected to a portable device. The sensors may, for instance, be embedded within a client device or may be connected to a client device via a wireless or wired connection. Exemplary sensors include but are not limited tom a keyboard, a keypad, a voice recorder, a bar code scanner, a clock, a camera, a GPS, an RFID sensor, or other data capture hardware. The type of sensor that may provide input to a specific field may be defined in the template input rules and may be embedded in the instantiated document.

The sensor interaction with a document is illustrated in the example depicted in FIG. 2. In the example, the value of the Time fields of document 201 may be automatically entered by a suitable clock sensor, while the Location fields may be automatically entered by a suitable Global Positioning Satellite (GPS) sensor. GPS data may, for instance, be used to provide the geographical location of the mobile computing device with an error of less than 100 meters. Under most operational conditions, the GPS data provides a location stamp having an error of less than 20 meters. Other sensor input fields such as, but not limited to, a Bar Code Scanner or and RFID scanner, may also be used.

FIG. 3 illustrates a further embodiment of the invention in which multiple users participate in the workflow of a business process. A document Doc(0) that is instantiated in step 301 using a template from the Template Repository 300, is assigned to User 1, The document is transferred by the Document Distribution module 302 to the client device 303 associated with the assigned user. User 1 then modifies the document Doc(1) in step 304 and submits it to the Document Distribution module 302 which routes the document to User 2, who is associated with client device 305. User 2 then modifies the document, now labeled Doc(2) in step 306 and submits it back to the Document Distribution module 302 which now routes the Document to User 3 on client device 307. User 3 modifies the document, now labeled Doc(3) in step 308 and submits it to Document Distribution 302 which, based on the embedded workflow rules, closes the business process and saves the document Doc(3) in step 309 in the Main Document Store 310. During this entire workflow, the original template is not needed after the initial document instantiation.

In another embodiment of the invention, the Document Distribution module 302 may utilize peer-to-peer protocols to transfer documents directly to users independent of any central distribution server.

FIG. 4 illustrates a further embodiment of the invention in which one or more templates are developed externally and imported into a Template Repository. The Template Builders 400, 401, and 402 are used to create templates that are stored in Template Repositories 403, 404, and 405, respectively. The Template Import module 406 is a component that allows one or more of the templates from the external repositories to be imported into a target template repository 407. The Template Repository 407 may in turn be made accessible as an external library itself, creating a cooperative network of Template libraries covering a wide range of industry business processes.

FIG. 5 illustrates a further embodiment of the invention in which a Geographic Information System (GIS) may be integrated with location information collected in Documents. The documents stored in the Main Document Store 500 may be made available to a GIS System 502 via a GIS Integration Layer 501. The location of a document as it progresses through a workflow may be displayed visually on a Map 503 or in Reports 504. As an external program, the GIS System may interact with other components of the invention, for example, but not limited to, to reassign a document to a driver who is geographically closer to another element in the workflow such as, for instance, a package to be picked up.

The embodiments detailed above may be conveniently implemented using one or more conventional general purpose digital computers and/or servers programmed according to the teachings of the present specification, as will be apparent to those skilled in the computer art. Appropriate software coding can readily be prepared by skilled programmers based on the teachings of the present disclosure, as will be apparent to those skilled in the art. The present embodiments may also be implemented by the preparation of application specific integrated circuits or by interconnecting an appropriate network of conventional component circuits, as will be readily apparent to those skilled in the art.

The above-described steps and embodiments may also be implemented using standard well-known programming techniques. The novelty of the above-described embodiment primarily lies not in any specific programming techniques but in the use of the steps described to achieve the described results. Software programming code which embodies the present invention is typically stored in permanent memory of some type, such as permanent storage of a workstation located at Portable Internet, Park Ridge, N.J. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

Numerous additional modifications and variations of the present embodiments are possible in view of the above-teachings. It is therefore to be understood that within the scope of the appended claims, the present embodiments may be practiced other than as specifically described herein.

### INDUSTRIAL APPLICABILITY

In the fields of transportation and distribution there is significant interest in creating, distributing, and updating information in a distributed system of Internet-based applications and programmable portable devices. Such a system would be of considerable utility in, for instance, improving productivity by allowing for real-time, or near real time, gathering of data including, but not limited to, the status of a business process and real-time, or near real time, updating of information or instructions relevant to the business process.

1-4. (canceled)

5. The method of claim 21 wherein said validation rules include a first rule indicating that the contents of said associated data fields must be a field name; and wherein said input rules include a second rule indicating that said associated data fields must be updated using a keypad.

6. The method of claim 5 wherein said permission rules include a third rule indicating that said associated data fields must be updated by a driver; and wherein said workflow rules include a fourth rule indicating that said associated data fields are a first step.

7. The method of claim 21 wherein said validation rules include a fifth rule indicating that the contents of said associated data fields must be unique across all instantiated documents using said template; wherein said input rules include a sixth rule indicating that said associated data fields must be updated using an RFID sensor; wherein said permission rules include a seventh rule indicating that said associated data fields must be updated by a supervisor; and wherein said workflow rules include an eighth rule indicating that said associated data fields are optional intermediate steps.

8-11. (canceled)

12. The system of claim 22 wherein said validation rules include a first rule indicating that the contents of said associated data fields must be a field name; and wherein said input rules include a second rule indicating that said associated data fields must be updated using a keyboard.

13. The system of claim 12 wherein said permission rules include a third rule indicating that said associated data fields must be updated by a driver; and wherein said workflow rules include a fourth rule indicating that said associated data fields are a first step.

14. The method of claim 22 wherein said validation rules include a fifth rule indicating that the contents of said associated data fields must be unique across all instantiated documents using said template; wherein said input rules include a sixth rule indicating that said associated data fields must be updated using an RFID sensor; wherein said permission rules include a seventh rule indicating that said associated data fields must be updated by a supervisor; and wherein said workflow rules include an eighth rule indicating that said associated data fields are optional intermediate steps.

15-18. (canceled)

19. The computer readable medium of claim 23 wherein said validation rules include a first rule indicating that the contents of said associated data fields must be a field name; wherein said input rules include a second rule indicating that said associated data fields must be updated using a keypad; wherein said permission rules include a third rule indicating that said associated data fields must be updated by a driver; and wherein said workflow rules include a fourth rule indicating that said associated data fields are a first step.

20. The computer readable medium claim 23 wherein said validation rules include a fifth rule indicating that the contents of said associated data fields must be unique across all instantiated documents using said template; wherein said input rules include a sixth rule indicating that said associated data fields must be updated using an RFID sensor; wherein said permission rules include a seventh rule indicating that said associated data fields must be updated by a supervisor; and wherein said workflow rules include an eighth rule indicating that said associated data fields are optional intermediate steps.

21. A method of deploying a distributed application, comprising the steps of:
creating a template defining a business process, said template comprising one or more data fields, and one or more computer interpretable instructions for implementing process rules associated with said data fields;
generating a document on a first computing device, said document comprising an instantiation of said template having one or more of said data fields populated according to said rules;
transmitting said document to a second computing device, located remote from said first computing device, via a wireless network; and,
updating, on said second computing device, one or more document data fields according to said rules using said instructions associated with, and transmitted with, said document, wherein said step of updating one or more data fields further comprises automatically associating a location stamp using Global Positioning Satellite (GPS) data with said updated document, said location stamp being indicative of the geographical location of said second computing device when said updating occurs, and wherein an error of said geographical location is less than 100 meters,
wherein said process rules associated with said document and data fields include validation rules, input rules, permission rules and workflow rules, thereby defining said business process.

22. A system of deploying a distributed application, comprising:
a template defining a business process, said template comprising a one or more data fields, and one or more computer interpretable instructions for implementing process rules associated with said data fields;
a document, comprising an instantiation of said template, having one or more of said data fields populated according to said rules while on a first computing device;
a second computing device, located remote from said first computing device, to which said document is transmitted via a wireless network; and,
an updating module, operable on said second computing device, whereby one or more document data fields are updated according to said rules using said instructions associated with, and transmitted with, said document, wherein said updating module automatically associates a location stamp comprising Global Positioning Satellite (GPS) data with said updated data field, said location stamp being indicative of the geographical location of said second computing device when said updating occurs, and wherein an error of said geographical location is less than 100 meters,
wherein said process rules associated with said data fields include validation rules, input rules, permission rules and workflow rules, thereby defining said business process.

23. A computer-readable medium, comprising instructions for:
creating a template defining a business process, said template comprising a one or more data fields, and one or more computer interpretable instructions for implementing process rules associated with said data fields;
generating a document on a first computing device, said document comprising an instantiation of said template having one or more of said data fields populated according to said rules;
transmitting said document to a second computing device, located remote from said first computing device, via a wireless network;
updating, on said second computing device, one or more document data fields according to said rules using said instructions associated with, and transmitted with, said document;
automatically associating a location stamp with said updated data field, said location stamp being indicative of the geographical location of said second computing device when said updating occurs, and wherein an error of said geographical location is less than 100 meters; and,
providing said location stamp with Global Positioning Satellite (GPS) data, wherein said process rules associated with said data fields include validation rules, input rules, permission rules and workflow rules, thereby defining said business process.
